(19) United States
(12) Patent Application Publication
(10) Pub. No.: US 2014/0112267 A1
(43) Pub. Date: Apr. 24, 2014

(54) RECEIVE DIVERSITY CONTROL IN TD-SCDMA

(71) Applicant: QUALCOMM Incorporated, San Diego, CA (US)

(72) Inventors: Jinghu CHEN, San Diego, CA (US); Qiang SHEN, San Diego, CA (US); Jilei HOU, Beijing (CN); Wanlun ZHAO, San Diego, CA (US); Insung KANG, San Diego, CA (US)

(73) Assignee: QUALCOMM Incorporated, San Diego, CA (US)

(21) Appl. No.: 14/050,234

(22) Filed: Oct. 9, 2013

Related U.S. Application Data
(63) Continuation-in-part of application No. 13/675,460, filed on Nov. 13, 2012.
(60) Provisional application No. 61/715,976, filed on Oct. 19, 2012.

(51) Int. Cl. H04B 7/08

(52) U.S. Cl. CPC H04B 7/08
USPC 370/329

(57) ABSTRACT

In a TD-SCDMA user equipment (UE) with multiple receive chains, receive diversity may be implemented where multiple receive chains may simultaneously activate to receive downlink signals. Receive diversity may be enabled when single chain reception provides undesired results and when receive diversity will not impact power consumption too much. A state machine controls receive diversity operation based on operating conditions such as control channel activity, successful control channel decoding, signal-to-interference ratio, and other factors.

### CROSS-REFERENCE TO RELATED APPLICATION

The present application claims the benefit of U.S. Provisional Patent Application No. 61/715,976, filed Oct. 19, 2012, in the names of Shen et al., the disclosure of which is expressly incorporated by reference herein in its entirety, and this application is a continuation-in-part of U.S. patent application Ser. No. 13/675,460 in the names of Chen et al., filed Nov. 13, 2012, the disclosure of which is expressly incorporated by reference herein in its entirety.

### BACKGROUND

1. Field

Aspects of the present disclosure relate generally to wireless communication systems, and more particularly, to control of receiver diversity in a TD-SCDMA network.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Packet Access (HSPA), which provides higher data transfer speeds and capacity to associated UMTS networks. HSPA is a collection of two mobile telephony protocols, High Speed Downlink Packet Access (HSDPA) and High Speed Uplink Packet Access (HSUPA), that extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

In an aspect of the present disclosure, a method of wireless communication with a user equipment (UE) having multiple receive chains is disclosed. The method includes enabling an additional receive chain upon successfully decoding a control channel. The method also includes determining an amount of control channel activity based on a filtered rate of successfully decoding the control channel. The filtered rate of successfully decoding is based on a previous decoding event of the control channel and a previous filtered rate of successfully decoding. Further, the method includes dynamically disabling the additional receive chain based at least in part on the amount of control channel activity.

In another aspect of the present disclosure, an apparatus for wireless communication with a user equipment (UE) having multiple receive chains is described. The apparatus includes a memory and at least one processor coupled to the memory. The processor(s) is configured to enable an additional receive chain upon successfully decoding a control channel. The processor(s) is also configured to determine an amount of control channel activity based on a filtered rate of successfully decoding the control channel. The filtered rate of successfully decoding is based on a previous decoding event of the control channel and a previous filtered rate of successfully decoding. The processor(s) is further configured to dynamically disable the additional receive chain based on the amount of control channel activity.

In yet another aspect of the present disclosure, a computer program product for wireless communication with a user equipment (UE) having multiple receive chains is described. The computer program product includes a non-transitory computer readable medium having encoded thereon program code. The program code includes program code to enable an additional receive chain upon successfully decoding a control channel. The program code further includes program code to determine an amount of control channel activity based on a filtered rate of successfully decoding the control channel. The filtered rate of successfully decoding is based on a previous decoding event of the control channel and a previous filtered rate of successfully decoding. Further, the program code includes program code to dynamically disable the additional receive chain based on the amount of control channel activity.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE in a telecommunications system.

FIG. 4 is a block diagram illustrating a receive chain controller according to one aspect of the present disclosure.

FIG. 5 illustrates a state machine according to one aspect of the present disclosure.

FIG. 6 is a block diagram illustrating a method for receive chain control according to one aspect of the present disclosure.

FIG. 7 is block diagram illustrating different means/modules/components in an exemplary apparatus.

FIG. 8 illustrates a state machine in accordance with one aspect of the present disclosure.

FIG. 9 is a flow diagram illustrating a process for wireless communications in accordance with aspects of the present disclosure.

FIG. 10 is a diagram illustrating an example of a hardware implementation for an apparatus employing a processing system according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

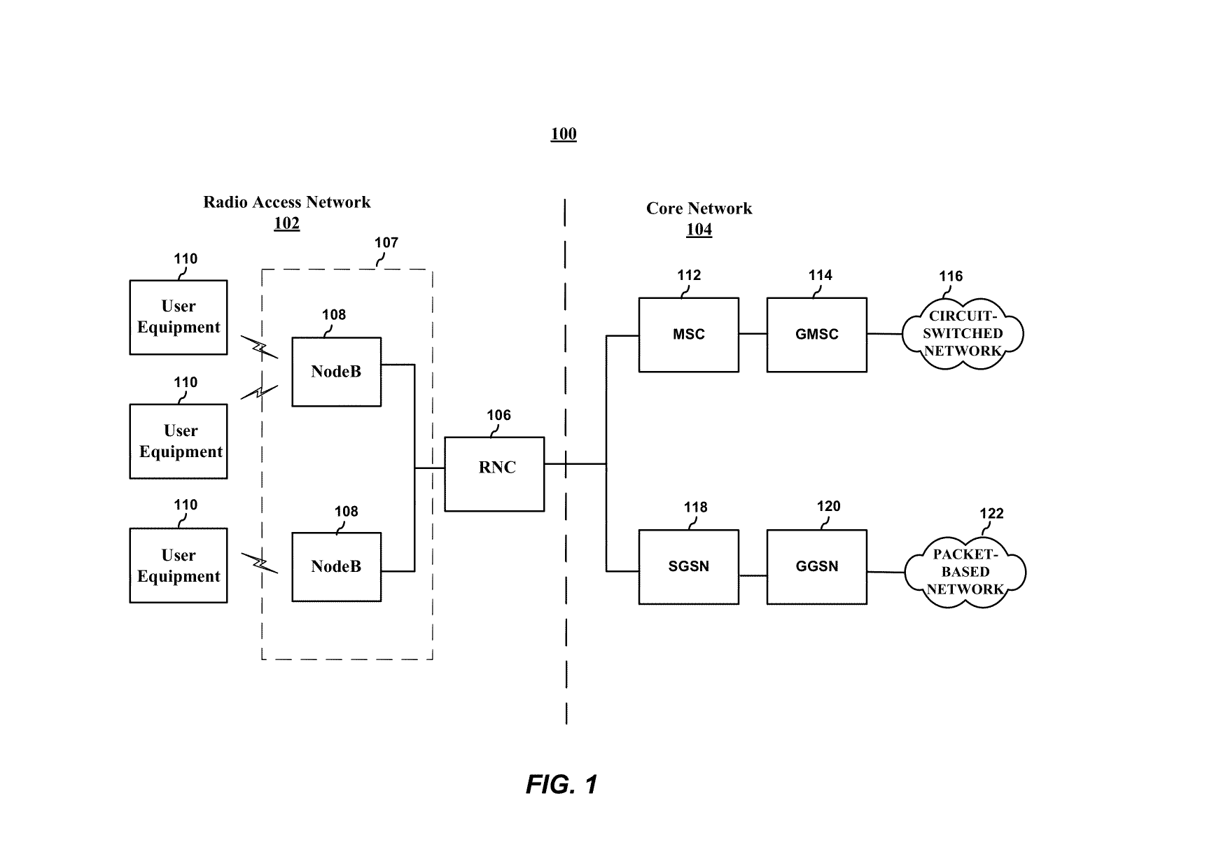

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

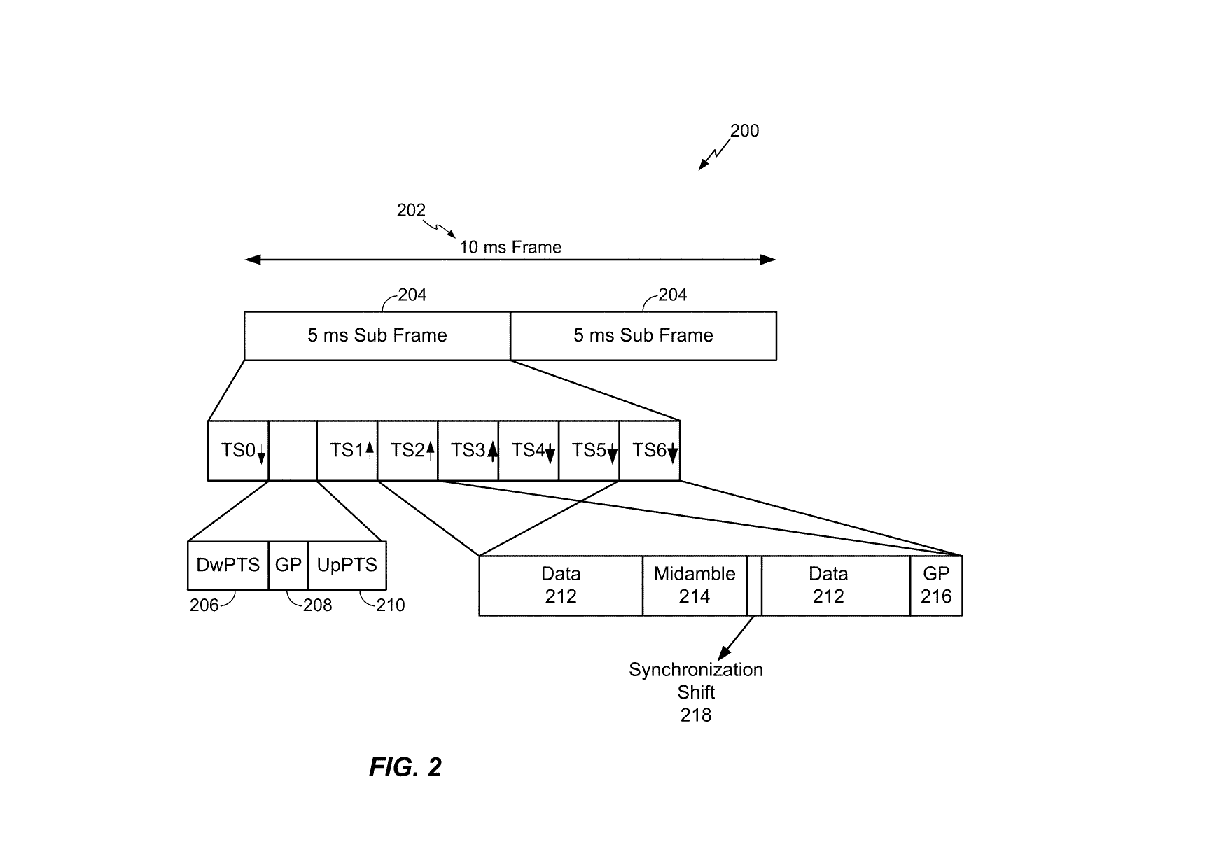

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including Synchronization Shift (SS) bits 218. Synchronization Shift bits 218 only appear in the second part of the data portion. The Synchronization Shift bits 218 immediately following the midamble can indicate three cases: decrease shift, increase shift, or do nothing in the upload transmit timing. The positions of the SS bits 218 are not generally used during uplink communications.

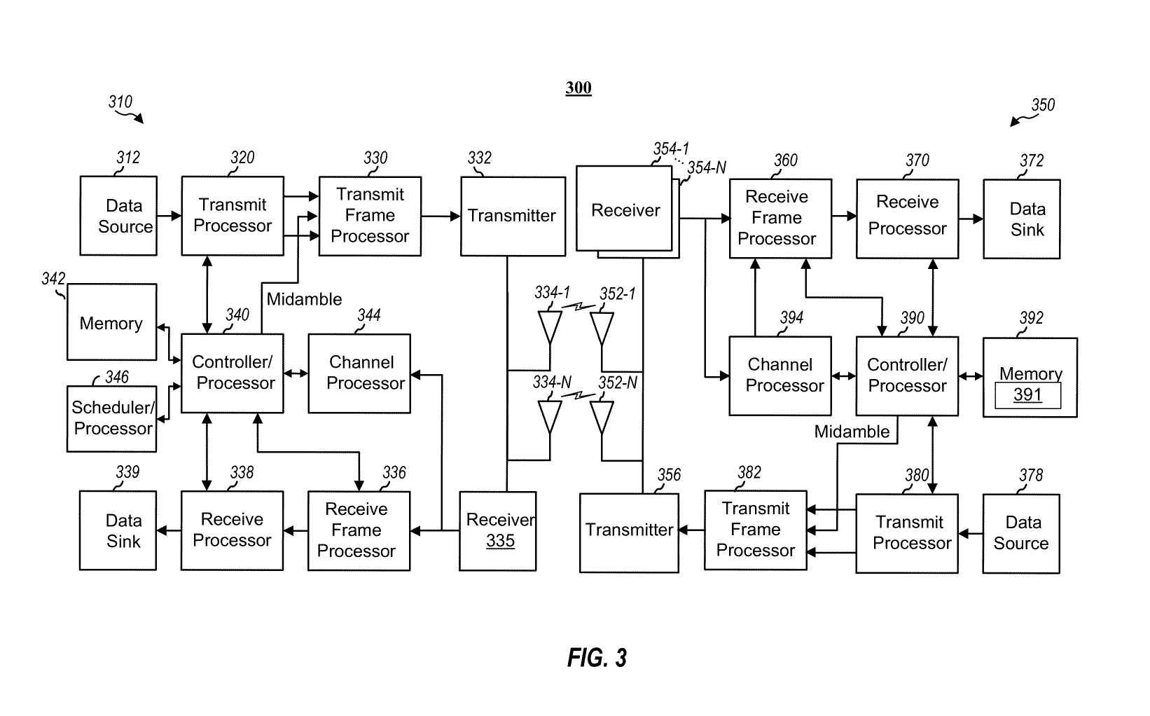

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334 (334-1, . . . , 334-N). The smart antennas 334 may be implemented with beam steering bidirectional adaptive antenna arrays or other similar beam technologies.

At the UE 350, at least one of the receivers 354 (354-1 . . . 354-N) receives the downlink transmission through an antennas 352 (352-1, . . . , 352-N) and processes the transmission to recover the information modulated onto the carrier. The information recovered by the receiver 354 (354-1 . . . 354-N) is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352 (352-1 . . . 352-N).

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The computer readable media of memories 342 and 392 may store data and software for the node B 310 and the UE 350, respectively. For example, the memory 392 of the UE 350 may store a receive chain control module 391 which, when executed by the controller/processor 390, configures the UE 350. A scheduler/processor 346 at the node B 310 may be used to allocate resources to the UEs and schedule downlink and/or uplink transmissions for the UEs.

### Receive Diversity Control in TD-SCDMA

In certain situations, a UE may have more than one communication chain capable of performing wireless communication. A communication chain may include components for performing wireless communication such as, for example, an antenna, processor, software, etc. A UE that has multiple receive chains may be said to have receive diversity (RxD). If multiple receive chains are tuned to different networks (such as a TD-SCDMA network or a GSM network) such UEs may simultaneously communicate on multiple networks. If multiple receive chains are combined to communicate with one network, the UE may employ receive diversity to improve communication performance with the network. For example, employing receive diversity for communications with a single network may improve data throughput or reduce a communication block error rate (BLER) compared to single chain receive activity. Employing receive diversity in this manner, however, may also increase UE power consumption.

To improve UE performance, a receive diversity control method is offered to manage UE performance, including performance quality, power consumption, and other factors. To manage receive diversity, measurements of UE operation and channel conditions may be made. The measurements may be analyzed by a receive diversity controller, which may control receive antennas and activate/deactivate receive diversity as conditions change to improve overall UE performance. For example, when channel conditions permit satisfactory UE communications, such as communications that exceed a BLER threshold, the controller may determine that a single antenna operation will be sufficient in the current condition. In other circumstances, such as when channel conditions are poor, a single antenna may not meet a desired BLER threshold. Therefore, multiple antennas may be activated to improve communication performance, although with higher power consumption due to activation of receive diversity.

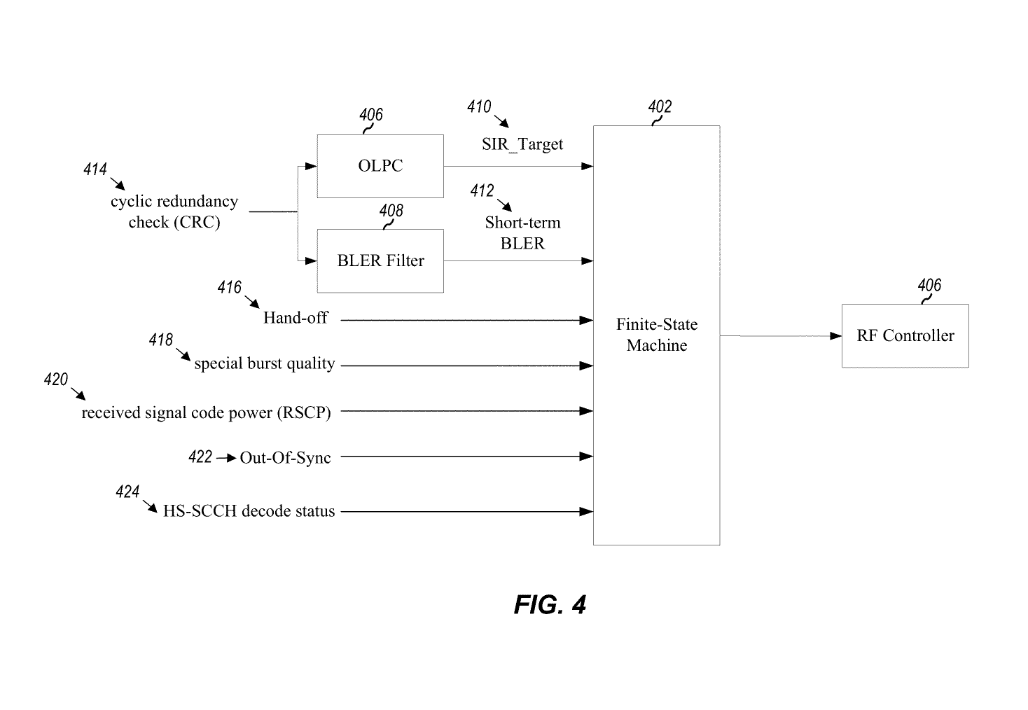

For UEs operating in a TD-SCDMA network a receive diversity control system is described below. A TD-SCDMA UE may employ a receive diversity controller as illustrated in FIG. 4.

As shown in FIG. 4, a finite state machine 402 may receive a variety of metrics from other blocks, process the received metrics, and determine whether receive diversity should be enabled to improve the call quality (for DPCH (dedicated physical channel) packets) or data throughput (for high speed (HS) packets). The finite-state machine 402 may control the receive diversity via the radio frequency (RF) controller 406 of the UE. In FIG. 4, a cyclic redundancy check (CRC) 414 indicates whether decoded packets are correctly received.

As shown in FIG. 4, various metrics may be considered by the finite state machine either alone or in different combinations. Other metrics in addition to those shown may also be considered. In one aspect, the SIR_Target 410 may be considered. SIR_Target 410 represents an expected signal-to-interference ratio (SIR) for a UE to achieve a block error rate in a certain channel condition. The SIR_Target 410 is a closed-loop power control (CLPC) set-point and may reflect the channel conditions of the UE. The SIR_Target 410 indicates an undesirable condition when the value exceeds a threshold. The undesirable condition may include, for example, high Doppler channel, shadowing, or the Node-B running out of transmit (Tx) power. The UE may enable receive diversity to mitigate the undesirable condition.

In another aspect, a short-term BLER 412 may be considered. A high short-term block error rate (BLER), or a large burst of frame errors, indicates a poor quality downlink. When the short-term BLER is detected to be high, receive diversity may be enabled in order to avoid a large burst of bad frames in a row.

A hand-off (HO) indicator 416 may also be received. In a baton handoff, after the UE receives a handover command from the Node-B, the UE first stops uplink transmission and switches to the new serving cell. As a result, for the downlink, there is no power control for a certain period of time during the handover. In addition, the handover state suggests that the UE is on a cell edge. Therefore, receive diversity may be enabled in a handover mode to decrease the call drop rate. In some cases, a hard handover may occur when the UE is at the cell edge. The hard handover may be less demanding of receive diversity because a hard handover starts with a random access procedure. Receive diversity may still be enabled to achieve improved cell edge performance.

Furthermore, a special burst quality (SBQ) 418 indicator may be considered. Special bursts are transmitted when there is no traffic in a DPCH channel. Both a BLER filter 408 and outer-loop power control (OLPC) 406 may be maintained once special bursts are detected. Consequently, the SIR_Target 410 and short-term BLER 412 are not updated on receiving special bursts. Alternatively, the special burst may be monitored to determine a quality to detect the current channel condition.

A received signal code power (RSCP) 420 may also be considered. The RSCP 420 may be measured based on a common pilot and indicates the path loss of the UE. When RSCP 420 is low, it indicates a bad reception condition. Receive diversity may be enabled when the RSCP 420 is less than a threshold.

An Out-of-Sync (OOS) indicator 422 may also be received. Out-of-sync in CELL_DCH (connected mode) may be declared after 160 ms of bad reception. Receive diversity may be enabled when the UE is out_of_sync. This test complements the BLER tests by examining the consecutive CRC failures instead of the average. When there is radio link failure, a UE enters the cell search stage, which is similar to operations performed during acquisition (ACQ).

The finite state machine may also consider a decode status 424 of the high speed-shared control channel (HS-SCCH) and whether it is successfully decoded. If successfully decoded, receive diversity may be enabled.

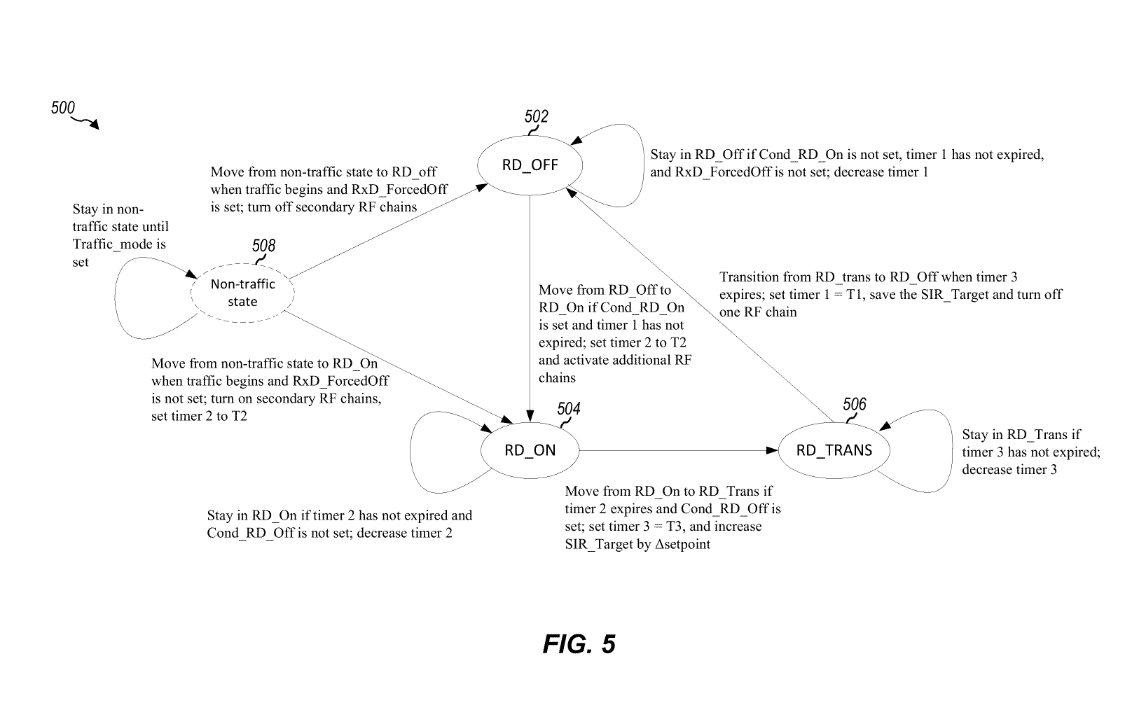

The receive diversity (RxD) finite state machine 500 according to one aspect of the present disclosure is illustrated in FIG. 5. As illustrated, in this aspect there are three traffic states 502, 504, and 506 and one non-traffic state 508. The three traffic states are receive diversity OFF (RD_OFF) 502, receive diversity ON (RD_ON) 504, and receive diversity transition (RD_TRANS) 506. When the state machine is in RD_OFF, only one receive chain is turned on. Both receive chains are turned on when the state is in RD_ON or RD_TRANS. RD_TRANS is a special intermediate transition state to control the transition between receive diversity on to receive diversity off. While in the RD_TRANS state the UE may allow for a smooth transition, and reduce performance loss that might otherwise occur when turning off receive diversity. Once there is a state transition, it may take effect on the subframe boundary with less than a 5 ms delay for a TD-SCDMA system.

The state machine 500 may be updated based on the most recent statistics. A variety of conditions and timers may be defined to control the transition between states. The conditions and timers may be configured to turn on receive diversity based on the finite state machine considerations described above (for example based at least in part on BLER, RSCP, SIR_Target, etc.) and the ability of receive diversity to improve UE performance. The conditions and timers may also be configured to turn off receive diversity to conserve UE power when the performance improvements for receive diversity may be outweighed by the increased power consumption. By adjusting the conditions and timers and employing the state machine, the UE may achieve receive diversity dynamic switching, allowing the UE to enable and disable receive diversity operations on the fly, as desired.

For example, a state machine condition Cond_RD_On may be computed to determine whether receive diversity should be turned on based on inputs to the state machine. Similarly, a state machine condition Cond_RD_Off may be computed to determine whether receive diversity should be turned off based on inputs to the state machine. Depending on different types of traffic, CondRD_On and CondRD_Off may be computed differently. A timer, timer 1, may indicate a floor of how long the UE should stay in the receive diversity off state under certain conditions. Another timer, timer 2, may indicate a floor of how long receive diversity should be on under certain conditions. These, and other conditions and timers, may determine when the state machine should transition states or stay in a same state.

For example, as shown in FIG. 5, the state machine will transition from the RD_OFF state to the RD_ON state if timer 1 has expired and the condition Cond_RD_On is set. Upon the transition from RD_OFF to RD_ON, a second (or greater) receive chain is activated and the second timer, timer 2, is reset to T2 to ensure that the UE stays in RD_ON for a time span of at least T2. When a UE is in RD_ON state, timer 2 decreases until it hits zero. The UE may stay in the RD_ON state as long as the timer 2 has not expired and the condition Cond_RD_Off has not been set. Timer 2 may be reset to T2 under certain conditions, for example if the BLER test (BLER_t) is true. This may ensure receive diversity continues to be active to counter an undesired BLER or otherwise improve UE performance.

If timer 2 expires and the condition Cond_RD_Off is set, the UE may transition from RD_ON to RD_TRANS. Upon this transition, a third timer, timer 3, may be set to T3 and the closed loop power control (CLPC) set-point, SIR_Target, may be increased by Δsetpoint. The state RD_TRANS may ensure that the signal to interference plus noise ratio (SINR) is not degraded too much in switching abruptly from RD_ON to RD_OFF. The increase in SIR_Target may send several power-control UP commands to a Node-B before shutting down the diversity receive chain.

When a UE is in the RD_TRANS state, timer 3 decreases until it expires. If timer 3 expires, the state machine will transition to RD_OFF and deactivate one of the two receive chains. The first timer, timer 1, will be set to T1, and the CLPC setpoint may reset to the value before transiting to the RD_TRANS state. The deactivated receive chain may be a fixed chain always designated for receive diversity, or may be the weaker receive chain in terms of the dynamic signal strength. Other factors may also be considered when determining which receive chain to deactivate.

A fourth state, the non-traffic state, may also be incorporated into the finite state machine of FIG. 5 to indicate when there is no RF traffic (indicated by the condition Traffic_mode). Once RF traffic resumes, the state machine will transition to either RD_OFF operation or RD_ON operation based on other conditions. Another state machine condition, RxD_ForcedOff may be implemented to indicate when receive diversity should be forced off when faced with certain conditions, such as the UE hitting a low power threshold.

The conditions and state machine may be configured to favor single receive chain operation, thus conserving UE power when possible, and to activate receive diversity only when single receive chain operation provides undesirable operation. For example, if a single receive chain operation reaches a level where increased power to the single chain may not improve operation (or further power increases are not possible) and a performance metric, such as SIR, continues to grow until it hits an upper bound, then receive diversity may be enabled to improve performance. When channel conditions improve, receive diversity may be disabled to conserve power. For example, the UE may enable receive diversity where the target BLER cannot be achieved with a single antenna, but may be achieved with receive diversity.

The SIR_Target may be also adjusted through an OLPC block driven by the packet CRC. If a CRC failure is received, the SIR_Target may be increased by Up_Stepsize. If a CRC pass is received, the SIR_Target may be decreased by Down_Stepsize. For example, for a target BLER of 1%, values may be set at Up_Stepsize=0.5 dB and Down_Stepsize=0.5/99 dB. In this case, the target BLER may be achieved if the SIR_Target trace may be maintained around a constant value without saturation. On the other hand, if the BLER target cannot be achieved, the SIR_Target will increase until being saturated. Note that Up_Stepsize and Down_Stepsize may change adaptively based on UE conditions. By adjusting the SIR_Target in this manner, the decision of whether to enable receive diversity by the UE can account for the channel conditions.

Because the SIR_Target value reflects whether the channel is in good condition and whether the transmit power gap is reached, SIR_Target thresholding may be applied in receive diversity control. Specifically the UE can turn on receive diversity when the SIR_Target is greater than a threshold and turn off receive diversity if the SIR_Target is less than the threshold. The value of the threshold determines the level of the SIR_Target, and therefore determines the tradeoff between receive diversity on time and Node-B transmit power. A larger threshold makes it more difficult to turn on receive diversity, and thus consume more Node-B transmit power.

A large threshold value may be preferred to ensure that receive diversity is turned on only if a single antenna is not sufficient to maintain the target BLER. If the target BLER can be achieved with a single antenna, despite a high transmit power and a high SIR_Target value, it may be desired to keep receive diversity off to save UE power.

The initial value of the SIR_Target should not be set too low, because otherwise, if the channel condition is bad, it may take a long time for the SIR_Target to reach the threshold. On the other hand, it is possible that when the channel conditions suddenly worsen, the SIR_Target may still be low, and a number of error packets may be received before the SIR_Target reaches the threshold. As a result, a burst of packet errors may occur during this transition period. A short-term BLER test may be applied to avoid consecutive packet errors during this period. The error burst can be further alleviated if the BLER threshold is set differently in RD_ON and RD_OFF states.

The short-term BLER may be measured via an infinite impulse response (IIR) filter driven by CRC. The short term BLER may be represented by:

BLER(n)=(1−α)·BLER(n−1)+α· C̅R̅C̅(̅n̅)̅

where CRC(n)=0 if frame-n has a CRC failure and CRC(n)=1 if frame-n has a CRC pass. The BLER tests may be defined as:

$$BLER\_Hi \_t = {⋃}_{i ∈ TrCH} ( {BLER}_{i} ( n ) > {Th}_{BLER\_Hi} )$$

in RD_OFF state, and

$$BLER\_Lo \_t = {⋃}_{i ∈ TrCH} ( {BLER}_{i} ( n ) < {Th}_{BLER\_Lo} )$$

in RD_ON state. Th_{BLER}_{_{—}}_{Lo} and Th_{BLER}_{_{—}}_{Hi} are threshold values. The test is performed over all TrCHs (transport channels) of all active CCTrCHs (coded composite transport channels). However, the test can also be performed for one particular transport channel.

In RD_OFF state, BLER_Hi_t is tested to see if BLER is too high to turn on receive diversity. The threshold Th_{BLER}_{_{—}}_{Hi} and the filter parameter α are set jointly such that in RD_OFF state, the BLER test is assured to trigger before a large number of consecutive frame errors are received.

In RD_ON state, BLERLo_t is tested to see if BLER is low enough to turn off receive diversity. A different BLER threshold, Th_{BLER}_{_{—}}_{Lo}, is used for the BLER test. Two thresholds Th_{BLER} may be used so that if receive diversity is triggered by the BLER test only, the UE does not switch between RD_ON and RD_OFF too frequently. For this purpose, Th_{BLER}_{_{—}}_{Lo} is set to be <Th_{BLER}_{_{—}}_{Hi} to allow the UE to stay in RD_ON state for a longer time. The BLER test may be updated periodically after one or multiple CRCs are received.

Based on an average BLER of each transport channel of a CCTrCH, the outer-loop power control module updates the SIR target of a CCTrCH. The same maximum SIR_Target may be considered in the SIR_Target test with the following thresholding operation:

$$SIR\_t = {⋃}_{j ∈ CCTrCH} {SIR\_ Target}_{j} > {Th}_{{SIR}_{j}}$$

where Th_{SIR} is the set SIR threshold. Here the test may be over all CCTrCH targets. If there is no CCTrCH, SIR_t=false. The SIR_Target test may be updated every 20 ms, even in high speed (HS) mode, according to one configuration.

The parameter SBQ_Ave may be defined as the average of the special burst quality (SBQ) over a time period of D_{SBQ}. The parameter SBQ_Ave may take special burst discontinuous transmission (DTX) into account. The SBQ test is the result of a thresholding operation (i.e., SBQ_t=SB_Detected & &(SBQ_Ave<Th_{SBQ})) where the test result (SBQ_t) is true when a special burst is detected (SB_Detected=true) and also the average of the special burst quality (SBQ_Ave) is below a threshold value (Th_{SBQ}).

Regarding the RSCP, the following test may be defined:

RSCP_{—}t=RSCP<Th_{RSCP}

where Th_{RSCP} is the set RSCP threshold and RSCP is the actual received signal code power.

Using these values, the state machine conditions CondRD_On and Cond_RD_Off, may be computed as below:

Cond_RD_On=HO_{—}t or (SBQ_{—}t or OOS_{—}t or SIR_{—}t or BLER_Hi_{—}t or RSCP_{—}t)

Cond_RD_Off=(not HO_{—}t) & (not BLER_Lo_{—}t) & (not SIR_{—}t) & (not SBQ_{—}t) & (not OOS_{—}t) & (not RSCP_{—}t)

where HO_t is true when a handoff occurs, OOS_t is true when the UE is out of synchronization.

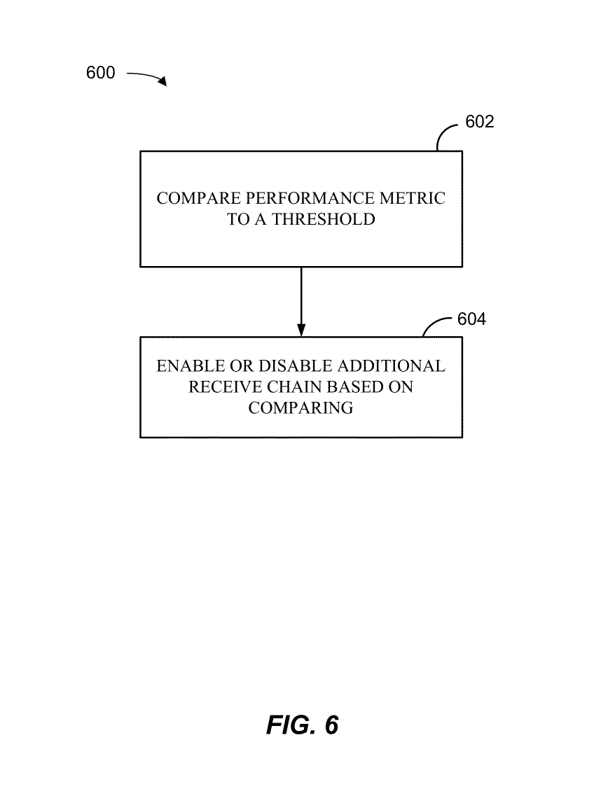

FIG. 6 shows a wireless communication method 600 according to one aspect of the disclosure. A UE compares a performance metric to a threshold, as shown in block 602. The UE also enables or disables an additional receive chain based at least in part on a result of the comparing, as shown in block 604.

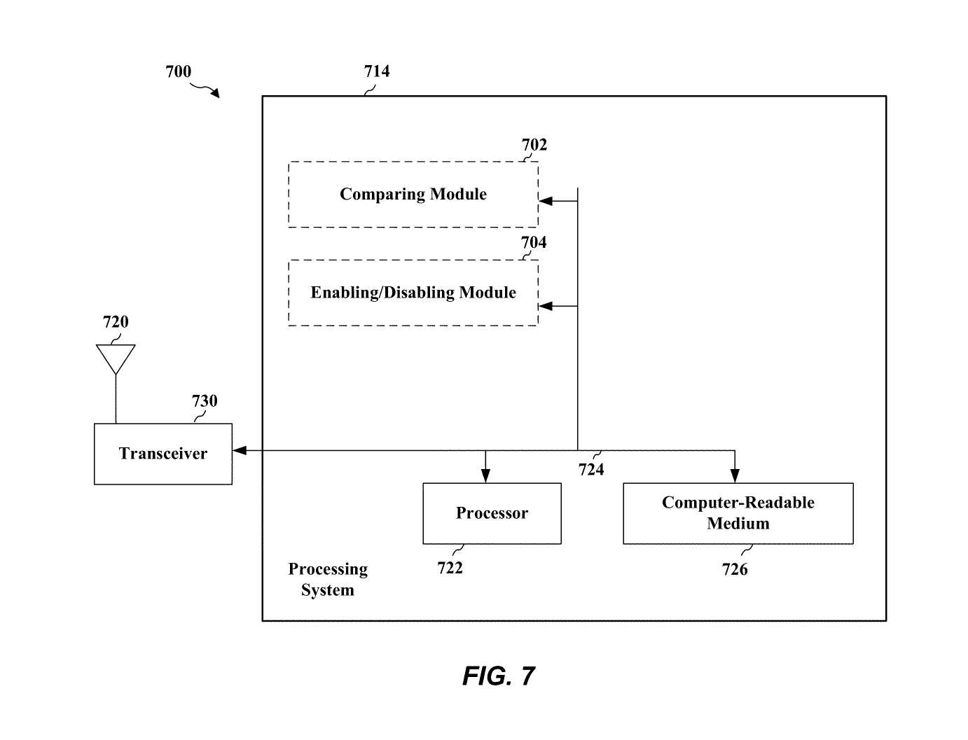

FIG. 7 is a diagram illustrating an example of a hardware implementation for an apparatus 700 employing a processing system 714. The processing system 714 may be implemented with a bus architecture, represented generally by the bus 724. The bus 724 may include any number of interconnecting buses and bridges depending on the specific application of the processing system 714 and the overall design constraints. The bus 724 links together various circuits including one or more processors and/or hardware modules, represented by the processor 722 the modules 702, 704, and the computer-readable medium 726. The bus 724 may also link various other circuits such as timing sources, peripherals, voltage regulators, and power management circuits, which are well known in the art, and therefore, will not be described any further.

The apparatus includes a processing system 714 coupled to a transceiver 730. The transceiver 730 is coupled to one or more antennas 720. The transceiver 730 enables communicating with various other apparatus over a transmission medium. The processing system 714 includes a processor 722 coupled to a computer-readable medium 726. The processor 722 is responsible for general processing, including the execution of software stored on the computer-readable medium 726. The software, when executed by the processor 722, causes the processing system 714 to perform the various functions described for any particular apparatus. The computer-readable medium 726 may also be used for storing data that is manipulated by the processor 722 when executing software.

The processing system 714 includes a comparing module 702 for comparing a performance metric to a threshold. The processing system 714 includes an enabling/disabling module 704 for enabling or disabling an additional receive chain based at least in part on a result of the comparing. The modules may be software modules running in the processor 722, resident/stored in the computer readable medium 726, one or more hardware modules coupled to the processor 722, or some combination thereof. The processing system 714 may be a component of the UE 350 and may include the memory 392, and/or the controller/processor 390.

In one configuration, an apparatus such as a UE is configured for wireless communication including means for comparing and means for enabling/disabling. In one aspect, the above means may be the antennas 352 352-1 . . . 352-N), the receiver 354 (354-1 . . . 354-N), the receive processor 370, the controller/processor 390, the memory 392, receive chain control module 391, comparing module 702, enabling/disabling module 704, and/or the processing system 714 configured to perform the functions recited by the aforementioned means. In another aspect, the aforementioned means may be a module or any apparatus configured to perform the functions recited by the aforementioned means.

In some aspects, receive diversity may be dynamically enabled and/or disabled based on other conditions. For example, an additional receive chain may be dynamically enabled and/or disabled based on receive metrics including, but not limited to, control channel activity and reliability. The control channel activity and reliability may be determined based on receive metrics such as a decode success rate, a schedule rate, signal to interference ratio (SIR), packet sequence numbers, other suitable receive metrics and combinations thereof.

When a control channel (e.g., HS-SCCH) is successfully decoded, a received control channel signal is dedicated to a specific UE. The successful decoding also indicates that a high speed physical downlink shared channel (HS-PDSCH) is being transmitted. As such, in accordance with aspects of the present disclosure, receive diversity (RxD) may be enabled for receiving the upcoming HS-PDSCH signal. Thus, a higher data rate and improved data throughput may be achieved.

The receiver (e.g., receiver 354 of FIG. 3) may also maintain a control channel decode success rate. In some aspects, the control channel decode success rate may be used to disable or turn off receive diversity. For example, when the decode success rate is below a threshold, receive diversity may be disabled.

In some aspects, a closed loop power control target, e.g., SIR_Target, may also be used to enable/disable receive diversity. The SIR_Target represents an expected signal-to-interference ratio (SIR) for a UE to achieve a block error rate (BLER) in a certain channel condition. For example, in some aspects, the SIR_Target may represent a maximum threshold limit for SIR (e.g., Th_SIR_Target) for a channel to maintain an acceptable quality level. When the SIR_Target for the channel is above the Th_SIR_Target, the channel quality may be deemed unacceptably low as the data transmitted may be unreliable. As such, the power consumed in transmitting and/or receiving data under such SIR condition may be wasted. Further, additional power may be consumed when retransmission is deemed necessary. In such circumstances, it may be beneficial to enable receive diversity to improve reliability and reduce the need for data retransmission.

Using the SIR_Target may also be beneficial because, in some instances, it may not be known, for example, whether a control channel (e.g., HS-SCCH) decode failure is due to poor link quality or whether the control channel was scheduled for another UE. That is, the success rate alone may not be sufficient to determine whether to disable/enable receive diversity. Thus, the power control target, e.g., SIR_Target, may be a proxy for channel reliability (i.e., link quality) and may be monitored to determine whether to enable receive diversity. Accordingly, in some aspects, receive diversity may be enabled when SIR_Target exceeds a threshold value.

Further, in some aspects, the SIR_Target may be dynamically adjusted. For example, the SIR_Target may be increased each time the HS-SCCH is successfully decoded. To help correlate the SIR_Target to link quality, the SIR_Target may also be modified based on packet sequence numbers. Each successfully decoded HS-SCCH packet includes a UE specific HS-SCCH cyclic sequence number (HCSN). The Node B increments the HCSN with each consecutive packet transmitted to a specific UE. As a result, a UE may determine whether any packets of the transmitted data have been missed by comparing the currently received HCSN with the HCSN of the previous packet received. If the difference between the current HCSN and the HCSN of the previously received packet is greater than 1, then the UE may determine that one or more data packets have been missed. The missed packet may be indicative of poor channel quality or an unreliable HS-SCCH.

Accordingly, to improve reliability an additional receive chain may be enabled, the SIR_Target may be adjusted up when a packet has been missed. In some aspects, the amount of adjustment may be based on the number of packets missed (i.e., ΔHCSN) or other reliability metrics. Thus, the SIR_Target may be dynamically adjusted based on a history of channel reliability.

By adjusting the SIR_Target relative to a threshold value, the likelihood of enabling receive diversity when the channel quality is poor may be increased. When the SIR_Target is above the SIR_Target threshold value, receive diversity may be enabled. On the other hand, when the SIR_Target is below the SIR_Target threshold value, indicating that the channel may be reasonably reliable, receive diversity may be disabled.

Receive diversity may also be enabled when the control channel activity is high. That is, an additional receive chain may be enabled when the control channel activity is above an activity threshold. Conversely, receive diversity may be disabled when the control active is below the activity threshold.

In some aspects, the control activity may correspond to a control channel schedule rate. For example, in some configurations, the control channel activity may be determined according to an HS_Schedule_Rate. HS_Schedule_Rate is an output of an IIR filter and reflects the activity of the HS-SCCH channel. The HS_Schedule_Rate may be defined as follows:

HS_Schedule_Rate(n)=(1−2^{-β})·(Schedule_Rate(n−1)+2^{-β}(SCCH_Success(n)+ΔHCSN)

The HS_Schedule_Rate includes two inputs: (1) SCCH_Success and (2) ΔHCSN. SCCH_Success defines whether the HS-SCCH channel was successfully decoded or not. That is, whether a received HS-SCCH signal is dedicated to a specific UE, meaning that a burst of data is being transmitted to the specific UE or not. When HS-SCCH is successfully decoded, the SCCH_Success is set to 1. On the other hand, when HS-SCCH is not successfully decoded, the SCCH_Success is set to 0.

The second input, ΔHCSN is a metric that reflects the reliability of the HS-SCCH channel. As discussed above, HCSN is cyclic sequence number transmitted with each packet transmitted to a specific UE. For example, the HCSN value may cycle between 0 to 7. Thus, when the change in HCSN value from one packet to the next is greater than 1, at least one data packet has been missed, which may indicate that the HS-SCCH channel is not reliable. Accordingly, the ΔHCSN input may be defined as follows:

ΔHCSN=(current_HCSN−last_HCSN−1+HCSN_Cycle)mod HCSN_Cycle

HCSN_Cycle corresponds to the span of the cycle (e.g., HCSN_Cycle is 8 when HCSN cycles between 0 and 7)

The HS_Schedule_Rate is also determined based on a previous control channel activity (i.e., HS_Schedule_Rate (n−1)). By using the previous control channel activity, the current control activity measure is based at least in part on a previous decoding event of the control channel and at least one previous filtered rate of successfully decoding. This may be beneficial because using additional decoding cycles may provide stability and more control over transitions between enabling and disabling receive diversity, thereby avoiding wasted power resulting from unnecessarily enabling and/or disabling receive diversity.

In one exemplary configuration, the receive diversity may be enabled based on the occurrence of any of the following conditions:

(1) SCCH_pass=true whenever HS_SCCH is successfully decoded

(2) SCCH_SIR_Target_Hi_t=SCCH_SIR_Target>SIR Threshold

(3) SCCH_Hi_active_t=HS_Schedule_Rate>SCCH_Thres_low, where

The SCCH_pass is a variable corresponding to whether a received HS-SCCH signal is dedicated to a specific UE, meaning that a burst of data is being transmitted to the specific UE or not. When SCCH_pass is True, receive diversity may be enabled to improve channel quality and throughput. On the other hand, when SCCH_pass is False, RxD may be disabled to reduce power consumption.

The SCCH_SIR_Target_Hit reflects the HS-SCCH reliability. The SCCH_SIR_Target is high when SIR_Target, as described above with respect to FIG. 4, is above a threshold value. This would indicate that the HS-SCCH channel reliability is less than desired. As such, receive diversity may be enabled to improve reliability of the HS-SCCH (and the PDSCH).

As discussed above, the HS_Schedule_Rate reflects the activity level of the HS-SCCH channel. The HS_Schedule_Rate may be defined as follows:

HS_Schedule_Rate(n)=(1−2^{-β})·HS_Schedule_Rate(n−1)+2^{-β}(SCCH_Success(n)+ΔHCSN)

where ΔHCSN=(current_HCSN−last_HCSN−1+HCSN_Cycle) mod HCSN_Cycle and SCCH_success=1 or 0.

When the activity level of the HS-SCCH channel is high (i.e., above an activity threshold) the value SCCH_Hi_active_t is true. As such, receive diversity may be enabled to improve throughput.

Conversely, in an exemplary configuration, the receive diversity may be disabled based on any of the following conditions:

(1) SCCH_pass=false whenever HS_SCCH is not successfully decoded

(2) SCCH_SIR_Target_Lo_t=SCCH_SIR_Target<SIR Threshold

(3) SCCH_Lo_active_t=HS_Schedule_Rate<SCCH_Thres_low

When the SCCH_pass variable is false, a received HS-SCCH signal is not dedicated to a specific UE. Because a burst of data is not being transmitted to the specific UE, the additional receive chain may not be necessary. As such, receive diversity may be disabled to reduce power consumption.

When the SCCH_SIR Target is below a SIR_Target threshold, the HS-SCCH channel may be deemed sufficiently reliable such that an additional receive chain may not be necessary. As such, receive diversity may be disabled to reduce power consumption.

When the activity level of the HS-SCCH channel is low (i.e., below an activity threshold) the value SCCH_Lo_active_t is true. As such, receive diversity may be disabled to reduce power consumption.

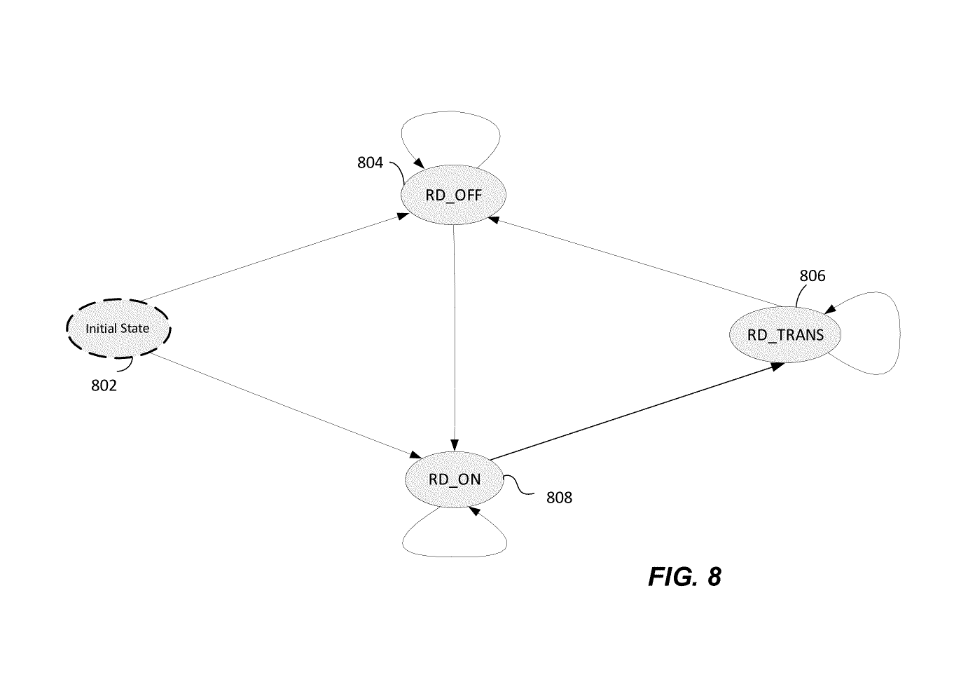

A receive diversity (RxD) finite state machine 800 according to one aspect of the present disclosure is illustrated in FIG. 8. As illustrated, in this aspect there is an initial state 802 and three traffic states 804, 806, and 808. The three traffic states are receive diversity OFF (RD_OFF) 804, receive diversity ON (RD_ON) 808, and receive diversity transition (RD_TRANS) 806.

The RD_ON state 808 is the state that turns on primary and secondary receive chains to turn on receive diversity. The RD_OFF state 804 is the state that turns off the secondary receive chain to disable receive diversity. The RD_Trans state 806 is still with receive diversity, but intentionally trains the NodeB transmitter to raise the transmit power to get ready for the RD_OFF state 804.

Referring to FIG. 8, from the initial state 802, receive diversity may be turned on or off. For example, when the HS-SCCH is successfully decoded, the state machine may be set to RD_ON 806 and receive diversity may be enabled. In some aspects, the receive diversity may also be enabled when the SIR_Target is above an SIR threshold and/or when the control channel activity is above an activity threshold value. On the other hand, the state machine may be set to RD_OFF 804 and receive diversity may be disabled when HS-SCCH is not successfully decoded, when the SIR_Target is below the SIR threshold and/or when control channel activity is below the activity threshold value.

When the state machine is in the RD_OFF state 804, only one receive chain is turned on. An additional receive chain is turned on when the state is in RD_ON 808 or RD_TRANS 806. RD_TRANS is a special intermediate transition state to control the transition between receive diversity on to receive diversity off. While in the RD_TRANS state 806, the UE may allow for a smooth transition, and reduce performance loss that might otherwise occur when turning off receive diversity. Once there is a state transition, it may take effect on the subframe boundary with less than a 5 ms delay for a TD-SCDMA system.

The state machine 800 may be updated based on the most recent statistics. A variety of conditions and timers may be defined to control the transition between states. The conditions and timers may be configured to turn on receive diversity based on the finite state machine considerations described above (for example based at least in part on, SIR_Target, schedule rate, successful HS-SCCH decode, etc.) and the ability of receive diversity to improve UE performance. The conditions and timers may also be configured to turn off receive diversity to conserve UE power when the performance improvements for receive diversity may be outweighed by the increased power consumption. By adjusting the conditions and timers and employing the state machine, the UE may achieve receive diversity dynamic switching, allowing the UE to enable and disable receive diversity operations on the fly as desired.

For example, a state machine condition Cond_RD_On may be computed to determine whether receive diversity should be turned on based on inputs to the state machine. Similarly, a state machine condition Cond_RD_Off may be computed to determine whether receive diversity should be turned off based on inputs to the state machine. Depending on different types of traffic, CondRD_On and CondRD_Off may be computed differently.

In some configurations, timers may control transitions between states to provide added stability. For example, a timer, timer 1 may indicate a floor of how long the UE should stay in the receive diversity off state under certain conditions. Another timer, timer 2, may indicate a floor of how long receive diversity should be on under certain conditions. These, and other conditions, and timers may also be used to determine when the state machine should transition states or stay in a same state.

For example, as shown in FIG. 8, the state machine will transition from the RD_OFF state 804 to the RD_ON state 808 if the high speed control channel is successfully decoded. In addition, the state machine may transition from RD_OFF state 804 to RD_ON state 808 if the SIR_Target is above a SIR threshold value (i.e., the channel is determined to be unreliable). In addition, the state machine may transition from RD_OFF state 804 to RD_ON state 808 if filtered control channel activity is above an activity threshold value.

Upon the transition from RD_OFF 804 to RD_ON 808, a second (or greater) receive chain is activated and a timer, timer Tran is set to T_{Tran} to ensure that the UE stays in RD_ON for a time span of at least T_{Tran}. The timer Tran corresponds to the response time for the NodeB to raise the transmit power. When the timer expires, the UE turns off RxD by transferring from the RD_TRANS state 806 to the RD_OFF state 804. Upon entering the RD_OFF state 804, the SIR_Target value may be restored.

When a UE is in the RD_ON state 808, timer T_{Tran} decreases until it hits zero. The UE may stay in the RD_ON state 808 as long as the timer T_{Tran} has not expired and the condition Cond_RD_Off has not been set.

During state transition of RD_ON 808 to RD_TRANS 806, the current SIR target may be saved and stored for later use when receive diversity is turned off.

Another state machine condition, RxD_ForcedOff may be implemented to indicate when receive diversity should be forced off when faced with certain conditions, such as the UE hitting a low power threshold. In addition, when state machine condition NOT RxD_ForcedOff is true, RxD may be enabled. For example, in some aspects, receive diversity may be enabled as a default setting.

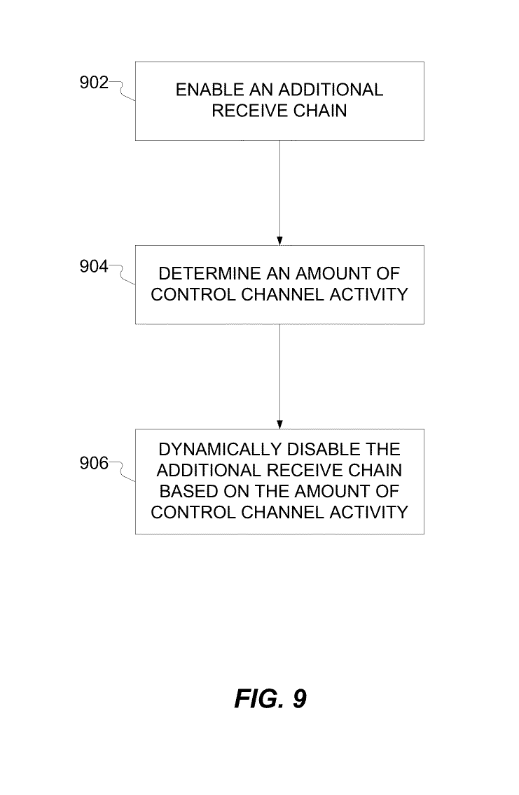

FIG. 9 is a flow diagram illustrating a process for wireless communications in accordance with aspects of the present disclosure. Referring to FIG. 9, at block 902, the process enables an additional receive chain upon successfully decoding a control channel (e.g., HS-SCCH). In some aspects, the additional receive chain may be enabled when an amount of control channel activity is above an activity threshold. Furthermore, in some aspects, the additional receive chain may be enabled when the channel quality of control channel is poor. For example, the additional receive chain may be enabled when SIR_Target is above a SIR threshold value.

At block 904, the process determines an amount of control channel activity. In some aspects, the control channel activity may be determined based on a filtered rate of successfully decoding the control channel. The filtered rate of successfully decoding may be based on at least one previous decoding event of the control channel and at least one previous filtered rate of successfully decoding.

At block 906, the process dynamically disables the additional receive chain based on the amount of control channel activity. In some aspects the additional receive chain may be disabled when the amount of control channel activity is below an activity threshold.

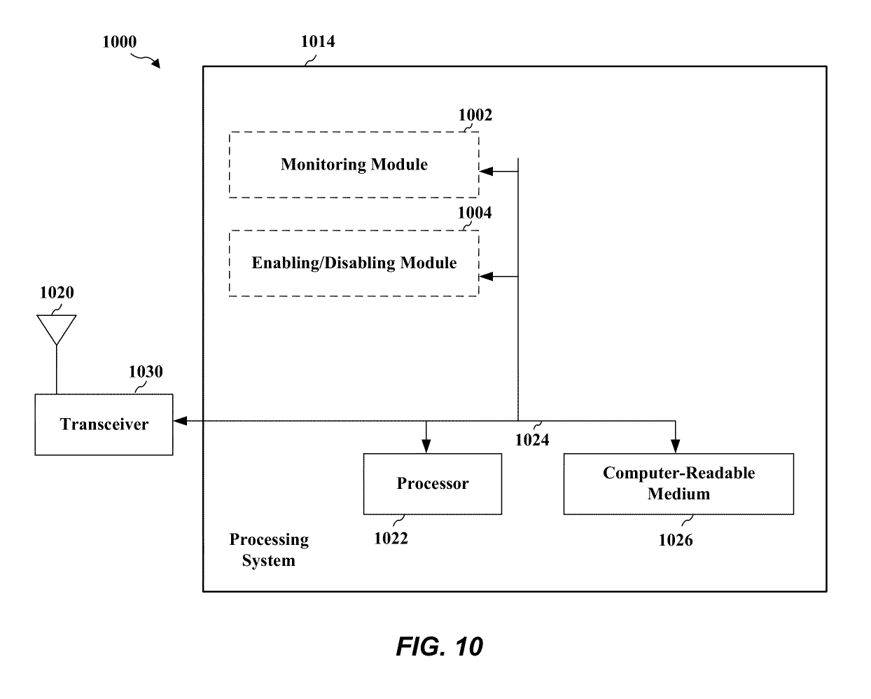

FIG. 10 is a diagram illustrating an example of a hardware implementation for an apparatus 1000 employing a processing system 1014. The processing system 1014 may be implemented with a bus architecture, represented generally by the bus 1024. The bus 1024 may include any number of interconnecting buses and bridges depending on the specific application of the processing system 914 and the overall design constraints. The bus 1024 links together various circuits including one or more processors and/or hardware modules, represented by the processor 1022 the modules 1002, 1004, and the computer-readable medium 1026. The bus 1024 may also link various other circuits such as timing sources, peripherals, voltage regulators, and power management circuits, which are well known in the art, and therefore, will not be described any further.

The apparatus includes a processing system 1014 coupled to a transceiver 1030. The transceiver 1030 is coupled to one or more antennas 1020. The transceiver 1030 enables communicating with various other apparatus over a transmission medium. The processing system 1014 includes a processor 1022 coupled to a computer-readable medium 1026. The processor 1022 is responsible for general processing, including the execution of software stored on the computer-readable medium 1026. The software, when executed by the processor 1022, causes the processing system 1014 to perform the various functions described for any particular apparatus. The computer-readable medium 1026 may also be used for storing data that is manipulated by the processor 1022 when executing software.

The processing system 1014 includes a monitoring module 1002 for determining an amount of control channel activity based on a filtered rate of successfully decoding the control channel. The processing system 1014 also includes an enabling/disabling module 1004 for dynamically enabling or disabling an additional receive chain based on the control channel activity.

The modules may be software modules running in the processor 1022, resident/stored in the computer readable medium 1026, one or more hardware modules coupled to the processor 1022, or some combination thereof. The processing system 1014 may be a component of the UE 350 and may include the memory 392, and/or the controller/processor 390.

In one configuration, an apparatus such as a UE is configured for wireless communication including means for enabling, means for determining, and means for dynamically disabling. In one aspect, the above means may be the antennas 352 (352-1 . . . 352-N), the receiver 354 (354-1 . . . 354-N), the receive processor 370, the controller/processor 390, the memory 392, receive chain control module 391, monitoring module 1002, enabling/disabling module 1004, and/or the processing system 1014 configured to perform the functions recited by the aforementioned means. In another aspect, the aforementioned means may be a module or any apparatus configured to perform the functions recited by the aforementioned means.

Several aspects of a telecommunications system has been presented with reference to TD-SCDMA systems. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication with a user equipment (UE) having a plurality of receive chains, comprising:
enabling an additional receive chain upon successfully decoding a control channel;
determining an amount of control channel activity based at least in part on a filtered rate of successfully decoding the control channel, the filtered rate of successfully decoding being based at least in part on at least one previous decoding event of the control channel and at least one previous filtered rate of successfully decoding; and
dynamically disabling the additional receive chain based at least in part on the amount of control channel activity.

2. The method of claim 1, in which the additional receive chain is dynamically disabled when the amount of control channel activity is below a threshold.

3. The method of claim 1, further comprising dynamically disabling the additional receive chain based at least in part on a channel reliability, indicated by a power control target.

4. The method of claim 3, further comprising dynamically adjusting the power control target based at least in part on a channel reliability history for the control channel.

5. The method of claim 4, in which the channel reliability history is based at least in part on packet sequence numbers.

6. The method of claim 3, further comprising dynamically adjusting the power control target based at least in part on each successful decode of the control channel.

7. The method of claim 1, in which the control channel is a high speed shared control channel (HS-SCCH).

8. An apparatus for wireless communication with a user equipment (UE) having a plurality of receive chains, comprising:
a memory; and
at least one processor coupled to the memory, the at least one processor being configured to:
enable an additional receive chain upon successfully decoding a control channel;
determine an amount of control channel activity based at least in part on a filtered rate of successfully decoding the control channel, the filtered rate of successfully decoding being based at least in part on at least one previous decoding event of the control channel and at least one previous filtered rate of successfully decoding; and
dynamically disable the additional receive chain based at least in part on the amount of control channel activity.

9. The apparatus of claim 8, in which the additional receive chain is dynamically disabled when the amount of control channel activity is below a threshold.

10. The apparatus of claim 8, in which the processor is further configured to dynamically disable the additional receive chain based at least in part on a channel reliability, indicated by a power control target.

11. The apparatus of claim 10, in which the processor is further configured to dynamically adjust the power control target based at least in part on a channel reliability history for the control channel.

12. The apparatus of claim 11, in which the channel reliability history is based at least in part on packet sequence numbers.

13. The apparatus of claim 10, in which the processor is further configured to dynamically adjust the power control target based at least in part on each successful decode of the control channel.

14. The apparatus of claim 8, in which the control channel is a high speed shared control channel (HS-SCCH).

15. An apparatus for wireless communication with a user equipment (UE) having a plurality of receive chains, comprising:
means for enabling an additional receive chain upon successfully decoding a control channel;
means for determining an amount of control channel activity based at least in part on a filtered rate of successfully decoding the control channel, the filtered rate of successfully decoding being based at least in part on at least one previous decoding event of the control channel and at least one previous filtered rate of successfully decoding; and
means for dynamically disabling the additional receive chain based at least in part on the amount of control channel activity.

16. The apparatus of claim 15, in which the additional receive chain is dynamically disabled when the amount of control channel activity is below a threshold.

17. The apparatus of claim 15, further comprising means for dynamically disabling the additional receive chain based at least in part on a channel reliability, indicated by a power control target.

18. The apparatus of claim 17, further comprising means for dynamically adjusting the power control target based at least in part on a channel reliability history for the control channel.

19. The apparatus of claim 17, further comprising means for dynamically adjusting the power control target based at least in part on each successful decode of the control channel.

20. A computer program product for wireless communication with a user equipment (UE) having a plurality of receive chains, comprising:
a non-transitory computer readable medium having encoded thereon program code, the program code comprising:
program code to enable an additional receive chain upon successfully decoding a control channel;
program code to determine an amount of control channel activity based at least in part on a filtered rate of successfully decoding the control channel, the filtered rate of successfully decoding being based at least in part on at least one previous decoding event of the control channel and at least one previous filtered rate of successfully decoding; and
program code to dynamically disable the additional receive chain based at least in part on the amount of control channel activity.
